(19) United States
(12) Patent Application Publication
(10) Pub. No.: US 2026/0295581 A1
(43) Pub. Date: Oct. 1, 2026

(54) THREE-DIMENSIONAL ASSAY DEVICE

(71) Applicant: INITO HEALTH INC., Houston, TX (US)

(72) Inventors: Varun Akur VENKATESAN, Bangalore (IN); Gautam SHARMA, Bangalore (IN); Siddharth PATTNAIK, Bangalore (IN)

(21) Appl. No.: 19/164,210

(22) PCT Filed: Mar. 11, 2024
(86) PCT No.: PCT/IN2024/050251

§ 371 Date: Sep. 11, 2025

(30) Foreign Application Priority Data
Mar. 11, 2023 (IN) 202241064638

(51) Int. Cl. B01L 3/00

(52) U.S. Cl. CPC B01L 3/5023; B01L 2200/026; B01L 2200/16; B01L 2300/0832; B01L 2300/12

(57) ABSTRACT

Disclosed is an assay device 10 for analyzing a sample including a three-dimensional member 1 having a polygonal or circular cross section further including a first end and a second end being opposite to each other. The assay device 10 further includes a carrier member extending from the first end towards the second end on an inner surface or an outer surface of the three-dimensional member 1 to at least a portion of the three-dimensional member 1, such that the carrier member is on at least half the surface area of the inner surface or the outer surface of the three-dimensional member 1.

### TECHNICAL FIELD

The present disclosure relates generally to test devices. More particularly, the present disclosure relates to assay devices for analyzing a sample and determining one or more body condition of a user.

### BACKGROUND

Test devices are apparatus that are used to measure any concentration of a chemical or some characteristics of a liquid.

Test devices are simple, effective analytical tool used for the rapid detection of an analyte in the field or on-site. A test device coated with a chemical that reacts with the analyte is either dipped in the sample solution or the sample is loaded onto the test device. The use of test devices for in-process detection is advantageous due to the ease of use and the high specificity offered by them. The results of test devices are either based on visual observation or the quantitative analysis using digital readers.

Test devices are the test strips that are multiple types, starting from a piece of paper that contains an indicator, that will change color depending upon the analyte present in the samples. The commonly used test strips are pregnancy strips, that have multiple tracks, conjugates, control, and test lines. Based on the test to be performed the antibodies in the test strips are modified/changed.

Commercially, the conjugate pads are disposed on the test devices relatively near the sample collection zone. Also, in some commercially available pads, the detector antibodies are coated all over the track of the test devices. The tracks of these test devices are made of a polymer and are slashed by way of guillotine cutter which slashed with a minimum thickness of 1 mm, that are large in thickness and requires ample volume of antibodies to be coated in order to react with the sample. If the volume in the surface is less on the track of the test devices, then the results will be disturbed. Also, the commercially available test devices include multiple membranes that overlap. Such overlapping of multiple membranes results in improper flow across the test devices.

Thus, there is a need for a technical solution that overcomes the aforementioned problems of conventional test devices that are thicker in size and require ample volume of detector agents, and conjugation antibodies.

### SUMMARY

In an aspect, an assay device for analyzing a sample is provided. The assay device includes a three-dimensional member having a polygonal or circular cross section and further includes a first end and a second end such that the second end being opposite to the first end. The assay device further includes a carrier member extending from the first end towards the second end on an inner surface or an outer surface of the three-dimensional member to at least a portion of the three-dimensional member, such that the carrier member is on at least half the surface area of the inner surface or the outer surface of the three-dimensional member.

In some aspects, the carrier member defines a fluid flow path from the first end towards the second end to transfer the sample.

In some aspects, the one or more antibodies immobilized on the carrier member.

In some aspects, the carrier member is made of a transparent material.

In some aspects, the three-dimensional member includes a hollow structure, and the carrier member such that the carrier member is on the inner surface of the hollow structure.

In some aspects, the carrier member is on at least ¾ of the surface area of the inner surface or the outer surface of the three-dimensional member.

In some aspects, the assay device further includes a first site including one or more detector reagents having one or more detector antibodies such that the one or more detector reagents conjugates with one or more analytes present in the sample.

In some aspects, the assay device further includes a second site and a third site having one or more immobilized biochemical reagents.

In some aspects, the first site, the second site and the third site are in fluid communication with the carrier member.

In some aspects, the first site is upstream of the second site and the third site and the second site is either upstream or at simultaneous position as of the third site.

In some aspects, the sample is a biological sample.

In some aspects, the assay device is a lateral flow assay.

In another aspect, a three-dimensional member for a lateral flow assay having a polygonal or circular cross section for diagnosing and monitoring one or more body condition of a subject includes the carrier member placed at least on half the surface area of the inner surface or the outer surface of the three-dimensional member.

In another aspect, a tubular test device for determining one or more body conditions that includes carrier member placed at least on half the surface area of the inner surface or the outer surface of the tubular test device.

### BRIEF DESCRIPTION OF DRAWINGS

The above and still further features and advantages of aspects of the present disclosure becomes apparent upon consideration of the following detailed description of aspects thereof, especially when taken in conjunction with the accompanying drawings, and wherein:

FIG. 1 illustrates an assay device, in accordance with an aspect of the present disclosure.

FIG. 2 illustrates an isometric view of a tubular test device, in accordance with an aspect of the present disclosure;

FIG. 3 illustrates an isometric view of an exemplary tubular test device, in accordance with an aspect of the present disclosure;

FIG. 4 illustrates a flowchart that depicts a method for determining one or more body conditions in the subject by way of the three-dimensional member, in accordance with an aspect of the present disclosure; and

FIG. 5 illustrates a flowchart that depicts a detection of one or more analytes by way of the tubular test device, in accordance with an aspect of the present disclosure.

To facilitate understanding, like reference numerals have been used, where possible, to designate like elements common to the figures.

### DETAILED DESCRIPTION

Various aspect of the present disclosure provides a test device and more particularly an assay device for analyzing a sample. The following description provides specific details of certain aspects of the disclosure illustrated in the drawings to provide a thorough understanding of those aspects. It should be recognized, however, that the present disclosure can be reflected in additional aspects and the disclosure may be practiced without some of the details in the following description.

The various aspects including the example aspects are now described more fully with reference to the accompanying drawings, in which the various aspects of the disclosure are shown. The disclosure may, however, be embodied in different forms and should not be construed as limited to the aspects set forth herein. Rather, these aspects are provided so that this disclosure is thorough and complete, and fully conveys the scope of the disclosure to those skilled in the art. In the drawings, the sizes of components may be exaggerated for clarity.

It is understood that when an element or layer is referred to as being “on,” “connected to,” or “coupled to” another element or layer, it can be directly on, connected to, or coupled to the other element or layer or intervening elements or layers that may be present. As used herein, the term “and/or” includes any and all combinations of one or more of the associated listed items.

Spatially relative terms, such as “top,” “bottom,” and the like, may be used herein for ease of description to describe one element or feature's relationship to another element(s) or feature(s) as illustrated in the figures. It is to be understood that the spatially relative terms are intended to encompass different orientations of the structure in use or operation in addition to the orientation depicted in the figures.

The subject matter of example aspects, as disclosed herein, is described with specificity to meet statutory requirements. However, the description itself is not intended to limit the scope of this patent. Rather, the inventor/inventors have contemplated that the claimed subject matter might also be embodied in other ways, to include different features or combinations of features similar to the ones described in this document, in conjunction with other technologies. Generally, the various aspects including the example aspects relate to an assay device of identifying one or more body conditions of a user.

As mentioned, there remains a need for an assay device that requires minimal antibody to perform a reaction and reduces the antibody wastages that are excess in the test strips. The present disclosure provides the assay device having a three-dimensional member that requires minimal number of antibodies to identify one or more body condition of a user. The present disclosure further provides a tubular assay device that requires minimal antibodies to identify one or more body parameters of a user.

The terms “assay device,” “tubular test device,” and “lateral flow assay” may refer to similar meaning/interpretation and may be interchangeably used throughout the specification.

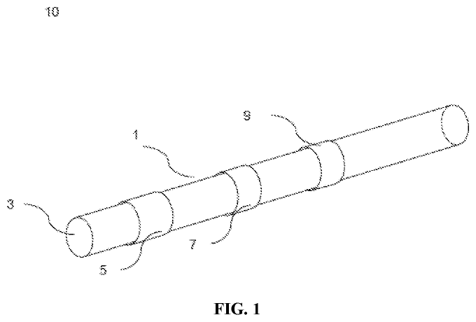

The terms “biological sample,” “bodily fluid” and “sample” may refer to similar meaning/interpretation and may be interchangeably used throughout the specification. FIG. 1 illustrates the assay device 10, in accordance with an aspect of the present disclosure. The assay device 10 may be adapted to analyze the sample. In some aspects, the assay device 10 may be adapted to analyze one or more analytes present in the sample. In some aspects, the sample may be a biological sample or any fluid. In some aspects of the present disclosure, the biological sample (herein after referred as ‘sample’) may be a bodily fluid selected from a group comprising, but not limited to, blood, serum, plasma, urine, saliva or sweat. Aspects of the present disclosure are intended to include and/or otherwise cover any type of the biological sample, including known, related, and later developed biological samples. In some aspects, the sample may be a fluid that may include, but not limited to, water, milk and the like. Aspects of the present disclosure are intended to include and/or otherwise cover any type of the fluid, including known, related, and later developed fluids. Examples of one or more analytes include, but not limited to, Estradiol glucuronide (E3G), Luteinizing Hormone (LH), Pregnanediol Glucuronide (PdG) and Follicle-stimulating hormone (FSH), antibody, metabolite, virus, bacteria, protein, and the like. Aspects of the present disclosure are intended to include and/or otherwise cover any type of the analytes, including known, related, and later developed analytes.

In some aspects, the assay device 10 may be provided for a lateral flow assay. Aspects of the present disclosure are intended to include and/or otherwise cover any type of the lateral flow assay, including known, related, and later developed lateral flow assays. The assay device 10 includes a three-dimensional member 1. The three-dimensional member 1 may have a polygonal or circular cross-section and adapted to receive the sample. In some aspects of the present disclosure, the three-dimensional member 1 may include, but not limited to, glass rod, glass rod, crystal rod, tubular rod, silicon rod, quartz glass rod and the like. Aspects of the present disclosure are intended to include and/or otherwise cover any type of the three-dimensional member 1, including known, related, and later developed three-dimensional member 1.

The three-dimensional member 1 may include a first end (not shown) and a second end (not shown). In some aspects, the first end and the second end of the three-dimensional member 1 acts as a dipping end and an excess flow end, respectively. In some aspects, the first end and second end may be placed opposite to each other. In some aspects, the first end is towards the user while the second end is away from the user.

In some aspects, the three-dimensional member 1 may include a hollow structure 3, a first site 5, a second site 7, third site 9 and a carrier member (not shown).

The three-dimensional member 1 may include a hollow structure 3 adapted to transfer the received sample within the three-dimensional member 1.

The first site 5 may include one or more detector reagents having one or more detector antibodies that may react with one or more analytes present in the sample to form a conjugate. In some aspects, the first site 5 may be disposed on the outer surface of the three-dimensional member 1. In some aspects, the first site 5 may be disposed on the inner surface or outer surface of the three-dimensional member 1. In some aspects, the first site 5, may be disposed adjacent to the dipping end of the three-dimensional member 1.

In some aspect, the second site 7 may be disposed on the inner surface or outer surface of three-dimensional member 1. In some aspects of the present disclosure, the second site 7 may be disposed downstream of the first site 5 such that the conjugated sample received from the first site 5 reacts on the second site 7. In some aspects, the second site 7 may include one or more first set of biochemical reagents immobilized on the second site 7. In some aspects, the one or more first set of biochemical reagents may include one or more detector reagents adapted to enable the conjugated sample (one or more analyte conjugated with one or more detector reagents) to react with one or more detector reagents immobilized on the second site 7 and generate a first result. In some aspects of the present disclosure, the one or more first set of biochemical reagents may include, but not limited to, one or more antibodies, conjugated antigens, and the like. Aspects of the present disclosure are intended to include and/or otherwise cover any type of the biochemical reagents, including known, related, and later developed biochemical reagents. In some aspects, the first result may be visualized by naked eye. In some aspects, the first result may be visualized by a scanner or imaging sensor configured on a handheld system. Aspects of the present disclosure are intended to include and/or otherwise cover any type of the imaging devices, including known, related, and later developed imaging devices.

In some aspects, the third site 9 may be disposed on the inner surface or the outer surface of the three-dimensional member 1. In some aspects, the third site 9 may be disposed downstream of the second site 7 and the first site 5, such that the conjugated sample received from the first site 5 reacts on the second site 7 and further unreacted and excess sample reacts on the third site 9 of the three-dimensional member 1. In some aspects, the third site 9 may include one or more second set of biochemical reagents immobilized on the third site 9. In some aspects, the one or more second set of biochemical agents may include one or more detector reagents immobilized such that the untreated/excess conjugated sample received from the second site 7 may react with react with the one or more detector reagents immobilized on the third site 9 and further generates a second result. In some aspects, the one or more second biochemical reagents may include, but not limited to, one or more polyclonal antibodies, one or more secondary monoclonal antibodies and the like. Aspects of the present disclosure are intended to include and/or otherwise cover any type of the biochemical reagents, including known, related, and later developed biochemical reagents. In some aspects, the second result may be visualized by naked eye. In some aspects, the second result may be visualized by a scanner or imaging sensor configured on a handheld system. Aspects of the present disclosure are intended to include and/or otherwise cover any type of the imaging devices, including known, related, and later developed imaging devices.

In some aspects, the first site 5 is upstream of the second site 7 and the third site 9 and the second site 7 is either upstream or at simultaneous position as of the third site 9.

In some aspects, the three-dimensional member 1 may further include the carrier member (not shown) adapted to define fluid flow path to transfer the sample between the first end and second end of the three-dimensional member 1. In some aspects, the first site 5, the second site 7 and the third site 9 are in fluid communication with the carrier member such that the sample received is transferred from the first end to the second end of the three-dimensional member 1 and through the first site 5, the second site 7 and the third site 9 by way of carrier member.

In some aspects, the carrier member may be disposed on the inner surface or outer surface of the three-dimensional member 1. In some aspects, the carrier member may extend from the first end to the second end of the three-dimensional member 1. In some aspects, the carrier member may be disposed to a certain portion or at least half of the surface area of the inner surface or outer surface of the three-dimensional member 1. In some aspects, the carrier member may be disposed on at least ¾ of the surface area of the inner surface or the outer surface of the three-dimensional member 1.

In some aspects, the carrier member may be coated on the outer surface of the three-dimensional member 1. In some aspects, the coating may be applied by dipping the three-dimensional member 1 until a pre-defined length into a solution (having one or more antibodies to capture one or more target analytes present in the sample). In some aspects, the carrier member may be sprayed on the outer surface of the three-dimensional member 1. In some aspects, the carrier member may be cast on the outer surface of the three-dimensional member 1.

In some aspects, the carrier member may be coated on the inner surface of the three-dimensional member 1. The inner coating may be applied by inserting a hollow carrier member into the hollow structure 3 of the three-dimensional member 1. In some aspects, the hollow structure 3 may include adhesive materials that may further stick the hollow carrier member to the inner surface of the three-dimensional member 1.

In some aspects, the carrier member may be immobilized with one or more antibodies. Examples of carrier member may include, but not limited to, a membrane, resin, nanoparticles, microparticles and the like. Aspects of the present disclosure are intended to include and/or otherwise cover any type of the carrier member, including known, related, and later developed carrier member. In some aspects, the assay device 10 may include one or more carrier members.

In some aspects, the carrier member may be composed of a transparent material. Examples of transparent material may include, but not limited to, epoxy resin, urea resin, silicone resin and glass and the like. Aspects of the present disclosure are intended to include and/or otherwise cover any type of the transparent material, including known, related, and later developed transparent materials.

In some aspects of the present disclosure, the diameter of the assay device 10 may range between 0.05 mm-0.5 mm. In a preferred aspect, the diameter of the assay device 10 may be less than 0.5 mm.

In an aspect of the present disclosure, the assay device 10 may be used to determine one or more body conditions of a subject by analyzing the sample. The one or more body conditions may include, but not limited to, ovulation, pregnancy, ectopic pregnancy, miscarriage, intrauterine pregnancy, intra-abdominal pregnancy, a poly cystic ovary syndrome and the like. Aspects of the present disclosure are intended to include and/or otherwise cover any type of the body condition, including known, related, and later developed body conditions.

In some aspects of the present disclosure, the assay device 10 may be provided to quantify one or more analytes present in the sample by visualizing the assay device 10 by a handheld device having one or imaging sensor.

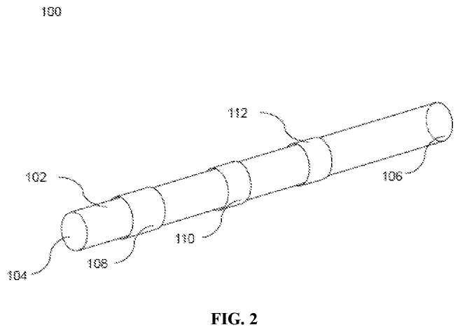

FIG. 2 illustrates an isometric view of a tubular test device, accordance with an aspect of the present disclosure. The tubular test device 100 may be adapted to receive a sample from the user. In some aspects of the present disclosure, the tubular test device 100 may include, but not limited to, a glass rod, a crystal rod, and the like. Aspects of the present disclosure are intended to include and/or otherwise cover any type of the tubular test device 100, including known, related, and later developed tubular structures.

The tubular test device 100 may include a hollow structure 102.

The tubular test device 100 may include a distal end 104 and a proximal end 106. The distal end 104 and the proximal end 106 of the tubular test device 100 may act as a dipping end and an excess flow end, respectively (for purposes of this disclosure, “distal end 104” refers to portion of the tubular test device 100 that is far from the user during normal use and “proximal end 106” refers to portion of the tubular test device 100 that is closer to the user during normal use). In some aspects, the distal end 104 and proximal end 106 of the tubular test device 100 may be opposite to each other.

The tubular test device 100 may further include a conjugate site 108, a test site 110 and a control site 112.

The conjugate site 108 may be disposed on the tubular portion 102. In some aspects of the present disclosure, the conjugate site 108 may be disposed adjacent to dipping end on the tubular test device 100 such that the conjugate site 108 receives sample from the distal end 104 of the tubular test device 100. In some aspects, the conjugate site 108 may include one or more detector antibodies or conjugated antigens to bind with one or more target analytes present in the sample.

The test site 110 may be disposed on the tubular portion 102. In some aspects of the present disclosure, the test site 110 may be disposed downstream of the conjugate site 108 such that the conjugated sample received from the conjugate site 108 reacts on the test site 110.

In some aspects of the present disclosure, the test site 110 may include one or more first detector reagents. In some aspects of the present disclosure, the test site 110 may be adapted to enable the sample to react with one or more first detector reagents and further enables to generate a first result. In some aspects of the present disclosure, the first result may be visualized by naked eye. In some aspects of the present disclosure, the one or more first detector reagents may include, but not limited to, one or more antibodies, conjugated antigens, and the like.

The control site 112 may be disposed on the tubular test device 100. In some aspects of the present disclosure, the control site 112 may be disposed downstream of the test site 110 and the conjugate site 108, respectively, such that the unreacted and excess conjugated sample reacts on the control site 112 disposed on the tubular test device 100. In some aspects, the control site 112 may include one or more second set of detector reagents. In some aspects of the present disclosure, the control site 112 may be adapted to enable the sample to react with one or more second set of detector reagents and further generate a second result. In some aspects of the present disclosure, the second result may be visualized by naked eye.

In some aspects of the present disclosure, the one or more second detector reagents may include, but not limited to, one or more polyclonal antibodies, one or more secondary monoclonal antibodies and the like. Aspects of the present disclosure are intended to include and/or otherwise cover any type of detector agents, including known, related, and later developed detector reagents.

In some other aspects of the present disclosure, the sample may be adapted to flow across the distal end 104 to the proximal end 106 by way of a carrier member (not shown). In some aspects of the present disclosure, the carrier member is a membrane. In some aspects, the membrane selected from a group, but not limited to, a non-woven polymer, silica gel, nitrocellulose, and the like. In some aspects, the carrier member may be disposed on the inner surface or outer surface of the tubular test device 100.

In an exemplary aspect, when the user dips the distal end 104 of the tubular test device 100 in a container having sample. The hollow structure 102 may be adapted to transfer the sample from the container to the proximal end 106 of the tubular test device 100 by way of nitrocellulose membrane coated on the upper surface of the tubular test device 100. The nitrocellulose membrane enables the sample to flow from the container to the proximal end 106. The sample may be adapted to react with the one or more antibodies on the conjugate pad 108. The sample may be adapted to flow further towards the excess flow end 106 by reacting with the test site 110 and the control site 112, respectively.

In some aspects of the present disclosure, the tubular test device 100 may be placed inside a body (not shown) of an apparatus (not shown) that enables the user to hold the tubular test device 100.

In some aspects of the present disclosure, the images of the tubular test device 100 may be captured by way of an imaging device (not shown). In some aspects of the present disclosure, the imaging device may include, but not limited to, a camera, a thermal imaging camera, an ultra-violet camera, an infrared camera, a night vision camera and the like. Aspects of the present disclosure are intended to include and/or otherwise cover any type of imaging device, including known, related, and later developed imaging device.

In some other aspects of the present disclosure, the captured image may further be analyzed to determine one or more body parameters of the user by way of a detection system. Examples of one or more body parameters may include, but not limited to, a including, but not limited to, Estradiol glucuronide (E3G), Luteinizing Hormone (LH), Pregnanediol Glucuronide (PdG) and Follicle-stimulating hormone (FSH) and the like. Aspects of the present disclosure are intended to include and/or otherwise cover any type of body parameters, including known, related, and later developed analytes.

In some aspects, the carrier member, the test site 110, the control site 112 may be sprayed on the outer surface of the tubular test device 100. In some aspects, the carrier member, the test site 110, the control site 112 may be cast on the outer surface of the tubular test device 100.

In some aspects, the carrier member, the test site 110, the control site 112 may be disposed on the inner surface of the tubular test device 100 by introducing the immobilized carrier member within the hollow structure 102 of the tubular test device 100.

In some aspects of the present disclosure, the diameter of tubular test device 100 may be less than 0.5 mm. In some other aspects of the present disclosure, the tubular test device 100 may require a little volume of one or more antibodies and one or more detector reagents.

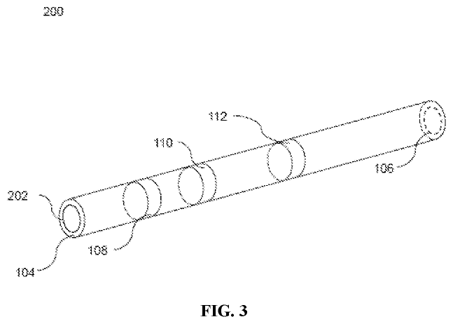

FIG. 3 illustrates an isometric view of an exemplary tubular test device 200, in accordance with an aspect of the present disclosure. The tubular test device 200 is substantially similar to that of the tubular test device 100 of FIG. 1 with like elements referred by way of like reference numerals. However, the conjugate pads 108, the test site 110 and the control site 112 are disposed inside the tubular test device 200, compared to the placement of the conjugate pads 108, the test site 110 and the control site 112 on the tubular test device 100. In some aspects of the present disclosure, the tubular test device 200 may include, but not limited to, a capillary tube, a glass tube, a crystal rod, and the like. Aspects of the present disclosure are intended to include and/or otherwise cover any type of the tubular test device 200, including known, related, and later developed tubular structures.

The tubular test device 200 may include a hollow structure 202.

The conjugate pad 108, the test site 110, and the control site 112 may be disposed in the hollow structure 202.

In some aspects of the present disclosure, the sample may be adapted to flow from the distal end 104 to the excess flow end 106 by way of a capillary force.

In an exemplary scenario, when the user dips the distal end 104 of the tubular test device 100 in the container having sample. The tubular portion 102 may be adapted to transfer the sample from the container to the proximal end 106 of the tubular test device 200 by way of the capillary force. The sample may be adapted to react with the one or more antibodies on the conjugate pad 108. The sample may be adapted to flow further towards the excess flow end 106 by reacting with the test site 110 and the control site 112, respectively.

In another exemplary aspect, when the user dips the distal end 104 of the tubular test device 100 in the container having sample. The tubular portion 102 may be adapted to transfer the sample from the container to the proximal end 106 of the tubular test device 100 by way of the nitrocellulose membrane coated across the hollow structure 202 of the tubular portion 102. The nitrocellulose membrane enables the sample to flow from the container to the proximal end 106. The sample may be adapted to react with the one or more antibodies on the conjugate pad 108.The sample may be adapted to flow further towards the excess flow end 106 by reacting with the test site 110 and the control site 112, respectively.

In some aspects, the carrier member, the test site 110, the control site 112 may be disposed on the inner or outer surface of the tubular test device 200.

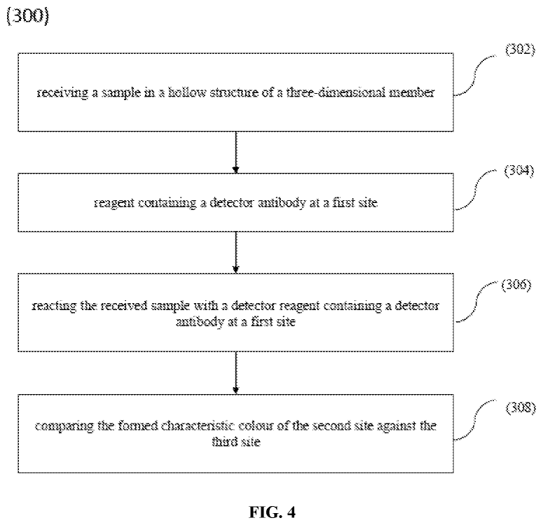

FIG. 4 illustrates a flowchart 300 that depicts a method for determining one or more body conditions in the subject by way of the three-dimensional member 1, in accordance with an aspect of the present disclosure.

At step 302, the hollow structure 3 of the three-dimensional member 1 may receive the sample.

At step 304, the received sample may react with one or more detector reagents containing a detector antibody immobilized on the first site 5 of the three-dimensional member 1. In some aspects of the present disclosure the flow may be enabled by way of at least one of, capillary force, carrier membrane and the like. Aspects of the present disclosure are intended to include and/or otherwise cover any type of the carrier member, including known, related, and later developed carrier member.

At step 306, the sample along with one or more detector antibodies may react at a second site 7 and a third site 9 having immobilized biochemical reagents to form a characteristic color. In some aspects, the biochemical agents include one or more detector reagents. In some aspects of the present disclosure, the one or more detector reagents may include, but not limited to, one or more antibodies, conjugated antigens, and the like. Aspects of the present disclosure are intended to include and/or otherwise cover any type of the detector agent, including known, related, and later developed detector agent.

At step 308, the formed characteristic color of the second site 7 may be compared against the third site 9.

In some aspects of the present disclosure, the method 300 is provided for determining the one or more body conditions of the user, such that the one or more body condition may be selected from a group including, but not limited to, ovulation, pregnancy, ectopic pregnancy, miscarriage, intrauterine pregnancy, intra-abdominal pregnancy, or a poly cystic ovary syndrome. Aspects of the present disclosure are intended to include and/or otherwise cover any type of the body condition, including known, related, and later developed body condition.

In some aspects, the results may be visualized by naked eye. In some aspects of the present disclosure, the three-dimensional member 1 may be further scanned by a handheld device having one or more imaging sensors for quantification of one or more analytes.

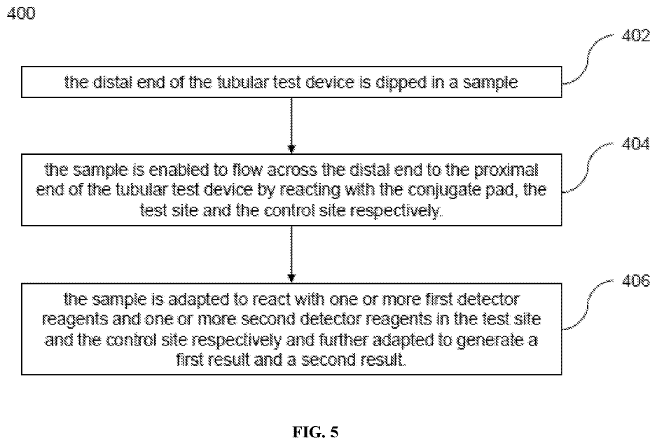

FIG. 5 illustrates a flowchart 400 that depicts a detection of one or more analytes by way of the tubular test device 100, in accordance with an aspect of the present disclosure.

At step 402, the distal end 104 of the tubular test device 100 may be dipped in the sample.

At step 404, the sample may be enabled to flow across the distal end 104 to the proximal end 104 of the tubular test device 100 by reacting with the conjugate pad 108, the test site 110 and the control site 112, respectively. In some aspects of the present disclosure the flow may be enabled by way of at least one of, capillary force, carrier member and the like. Aspects of the present disclosure are intended to include and/or otherwise cover any type of the carrier member, including known, related, and later developed carrier member.

At step 406, the sample may be adapted to react with the one or more first detector reagents and the one or more second detector reagents in the test site 110 and the control site 112 respectively and further adapted to generate the first result and the second result.

### Advantages of the Present Invention—

1. The assay device of the present disclosure may require less amount of one or more antibodies, detector reagents than commercially available test devices as surface area of the assay device is small.
2. The assay device of the present disclosure may enable the user or an imaging sensor to capture an image from any side of the assay device.
3. The assay device of the present disclosure may be adapted to determine concentration of analyte or reaction in the test site or the control site with more accuracy as it captures images of any side or one or more sides of the assay device.
4. The diameter of the assay device of the present disclosure may be less than 0.5 mm and may require less volume of one or more antibodies, detector reagents.
5. The assay device may have a thinner assay design, that may enable to design multiple assays to fit inside a limited space.
6. The assay device of the present disclosure may eliminate a need for multiple layers or overlapping of carrier member.
7. The assay device of the present disclosure may be cost effective, as it requires very little volume of one or more antibodies, detector reagents.
8. The method of the present disclosure is non tedious as the results can be generated by any user and it does not require any technical skills.
9. The device of the present disclosure captures images from various sides and provides more accurate concentration values of analytes.

The foregoing discussion of the present disclosure has been presented for purposes of illustration and description. It is not intended to limit the present disclosure to the form or forms disclosed herein. In the foregoing Detailed Description, for example, various features of the present disclosure are grouped together in one or more aspects, configurations, or aspects for the purpose of streamlining the disclosure. The features of the aspects, configurations, or aspects may be combined in alternate aspects, configurations, or aspects other than those discussed above. This device of disclosure is not to be interpreted as reflecting an intention. The present disclosure requires more features than are expressly recited in each claim. Rather, as the following claims reflect, inventive aspects lie in less than all features of a single foregoing disclosed aspect, configuration, or aspect. Thus, the following claims are hereby incorporated into this Detailed Description, with each claim standing on its own as a separate aspect of the present disclosure.

Moreover, though the description of the present disclosure has included description of one or more aspects, configurations, or aspects and certain variations and modifications, other variations, combinations, and modifications are within the scope of the present disclosure, e.g., as may be within the skill and knowledge of those in the art, after understanding the present disclosure. It is intended to obtain rights which include alternative aspects, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

We claim:

1. An assay device 10 for analyzing a sample, the device comprising:
a three-dimensional member 1 having a polygonal or circular cross section, the three-dimensional member 1 comprising a first end and a second end, the second end being opposite to the first end; and
a carrier member extending from the first end towards the second end on an inner surface or an outer surface of the three-dimensional member 1 to at least a portion of the three-dimensional member 1,
wherein the carrier member is on at least half the surface area of the inner surface or the outer surface of the three-dimensional member 1.

2. The assay device 10 as claimed in claim 1, wherein the carrier member defines a fluid flow path from the first end towards the second end to transfer the sample.

3. The assay device 10 as claimed in claim 1, further comprising one or more antibodies immobilized on the carrier member.

4. The assay device 10 as claimed in claim 1, wherein the carrier member is made of a transparent material.

5. The assay device 10 as claimed in claim 1, wherein the three-dimensional member 1 comprises a hollow structure 3 and the carrier member is on the inner surface of the hollow structure 3.

6. The assay device 10 as claimed in claim 1, wherein the carrier member is on at least ¾ of the surface area of the inner surface or the outer surface of the three-dimensional member 1.

7. The assay device 10 as claimed in claim 1, further comprising a first site 5 comprising one or more detector reagents having one or more detector antibodies such that the one or more detector reagents conjugates with one or more analytes present in the sample.

8. The assay device 10 as claimed in claim 7, further comprising a second site 7 and a third site 9 having one or more immobilized biochemical reagents.

9. The assay device 10 as claimed in claim 1, wherein the first site 5, the second site 7 and the third site 9 are in fluid communication with the carrier member.

10. The assay device 10 as claimed in claim 1, wherein the first site 5 is upstream of the second site 7 and the third site 9 and the second site 7 is either upstream or at simultaneous position as of the third site 9.

11. The assay device 10 as claimed in claim 1, wherein the sample is a biological sample.

12. The assay device 10 as claimed in claim 1, wherein the assay device 10 is a lateral flow assay.

13. A three-dimensional member 1 for a lateral flow assay having a polygonal or circular cross section for diagnosing and monitoring one or more body conditions of a subject comprising: a carrier member placed at least on half the surface area of the inner surface or the outer surface of the three-dimensional member 1.

14. A tubular test device 100 for determining one or more body conditions, comprising:
carrier member placed at least on half the surface area of the inner surface or the outer surface of the tubular test device 100.
